(19) United States
(12) Patent Application Publication
(10) Pub. No.: US 2004/0093094 A1
(43) Pub. Date: May 13, 2004

(54) Method of converting keyboard command entres and storage medium

(75) Inventor: Yang-Yen Lin, Taipei (TW)

Correspondence Address: QUINTERO LAW OFFICE, 1617 BROADWAY, 3RD FLOOR, SANTA MONICA, CA, 90404, US

(73) Assignee: Mitac Technology Corp.

(21) Appl. No.: 10/352,678

(22) Filed: Jan. 28, 2003

(30) Foreign Application Priority Data
Nov. 12, 2002 (TW) 91133183

(51) Int. Cl. G05B 15/00; G06F 17/00; G09G 5/00

(52) U.S. Cl. 700/1; 700/90; 700/84

(57) ABSTRACT

A method of converting keyboard command entry in a computer system is provided. First, a common key table is provided recoding the corresponding relationships between a plurality of common keys and function keys used by application programs in the computer system. Then, a background program activates and monitors the functional application program of the computer a system. Thereafter, the background program loads the common key table according to the executing application program of the computer system. Finally, entry keys are assigned to the function keys defined in the functional application program according to the common key table when the entry key is one of the common keys.

### BACKGROUND OF THE INVENTION

1. Field of the Invention

The present invention relates to a method of converting keyboard command entry, and in particular to converting keyboard command entries by a background program.

2. Description of the Related Art

A computer system is equipped with various devices, which the keyboard is one of the most important. Applications frequently assign their own functions to keys of the keyboard.

For example, a TV application program may use the [Enter] key as a function key to play TV programs and a DVD application program may use the [P] key as a function to play DVD movies.

The drawback of the conventional command entry scheme is that the application programs may use different function keys to perform the same or similar operations. In the above example, the TV application program and the DVD application program adopt the [Enter] key and the [P] key, respectively, to perform the play operation. Another example is the volume control. The TV application program may use the [←] and [→] arrow keys as the volume control keys, but the DVD application program may use the [<] and [>] keys as the volume control keys. In this circumstance, users must remember the different functions defined by various application programs and can easily confuse the key functions for the corresponding application programs.

### SUMMARY OF THE INVENTION

Accordingly, an object of the invention is to provide common key tables for different application programs. Hence, a method of keyboard command entry for different application programs assigns the same or similar functions to function keys.

To achieve the above object, the present invention provides a method of converting keyboard command entries in a computer system.

First, a common key table is provided recoding the corresponding relationships between a plurality of common keys and function keys used by application programs in the computer system. Then, a background program activates and monitors the functional application program of the computer system. Thereafter, the background program loads the common key table as according to the executing application program of the computer system. Finally, entry keys are assigned to the function keys defined in the functional application program according to the common key table when the entry key is one of the common keys.

### BRIEF DESCRIPTION OF THE DRAWINGS

The present invention can be more fully understood by reading the subsequent detailed description and examples with references made to the accompanying drawings, wherein:

FIGS. 1a and 1b are flowcharts illustrating the method of converting keyboard command entries in a computer system according to the embodiment of the present invention;

FIG. 2 is a schematic view showing common key tables for the DVD application program and the TV application program.

### DETAILED DESCRIPTION OF THE INVENTION

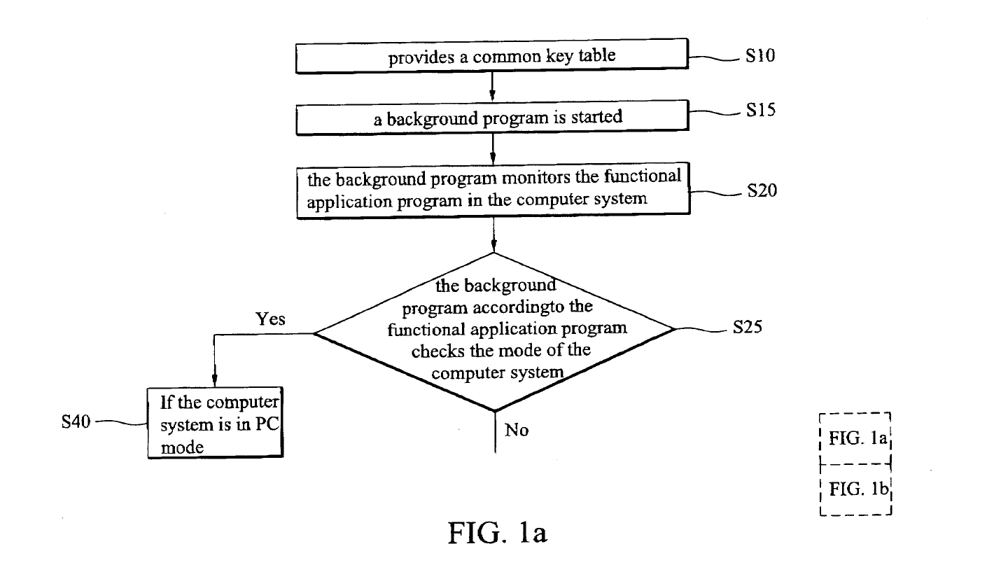

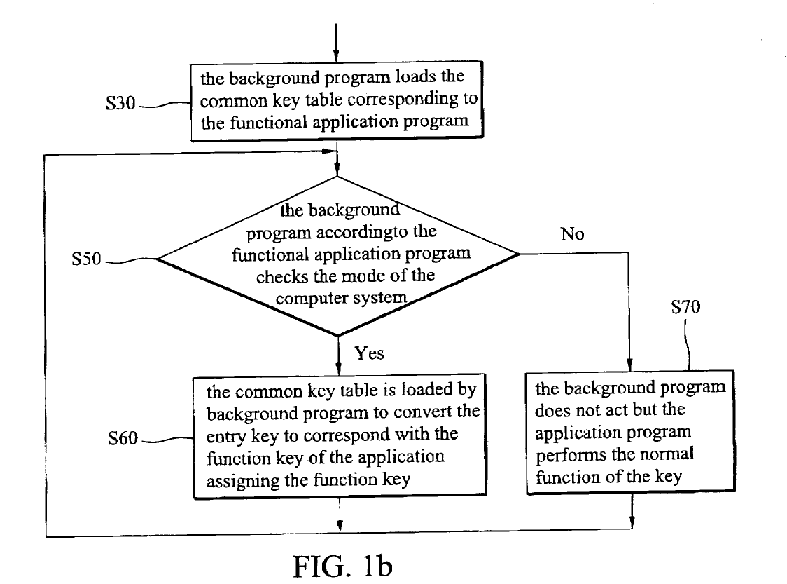

FIGS. 1a and 1b illustrate the method of converting keyboard command entries in a computer system according to the embodiment of the present invention.

First, step S10 provides a common key table. The common key table records a plurality of common keys. The common keys in the common key table have a corresponding relationship with function keys of an application program of the computer system. As mentioned, different application programs have different function keys. A function key is used to perform a designated function in the application program. The definition of common keys in the embodiment of the present invention is a group of simulated function keys. The group of function keys correspond to the same or similar functions in an application program. For is example, the [Enter] key in TV application program and the [P] key in the DVD application program both can be assigned to a common key.

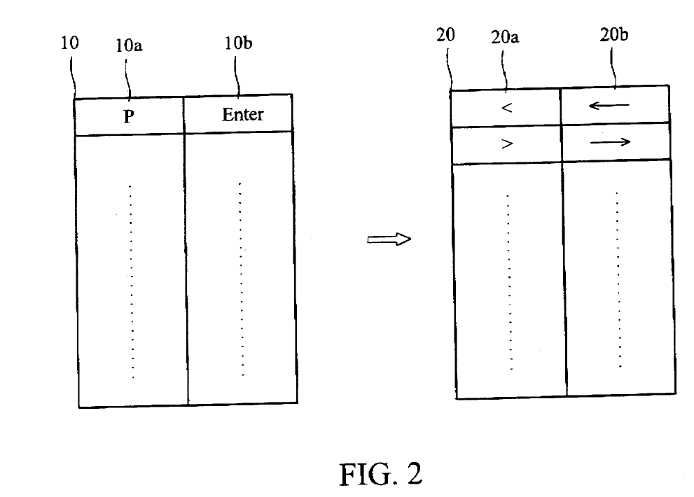

FIG. 2 shows common key tables for the DVD application program and the TV application program according to the embodiment of the present invention.

In FIG. 2 symbol 10 is a common key table for the DVD application program, and symbol 20 is a common key table for the TV application program. In this example, a play movie function key in the DVD application program is [p]. A decrease volume function key in the DVVD application program is [←]. An increase volume function key in the DVD application program is [→]. In the TV application program, TV program activation function key is [Enter]. A decrease volume function key in the TV application program is [<]. An increase voice function key in the TV application program is [>]. The DVD application program and the TV application program have different function keys performing the same or similar operations. In the present invention, the [Enter], [←] and [→] keys are defined as a group of common keys. The common key table 10 records a corresponding relationship between keyboard function keys 10a of the DVD application program and common keys 20a. The common key table 20 records a corresponding relationship between keyboard function keys 10b of the TV application program and common keys 20b.

The FIG. 2 shows common key tables designed for different application programs and only records keys for functions different from common keys. The present invention has been described in embodiments, but is not limited. Those familiar with the scope will recognize the potential of different common key tables. The single common key table recodes a corresponding relationship to all of the function keys and common keys.

In step S15, a background program is started. In steps S20, the background program monitors the functional application program in the computer system.

In step S25, the background program according to the functional application program checks the mode of the computer system. If the computer system is in PC mode, the background program does not perform key transforming functions (Step S40), and the keyboard function performs is a normal PC state in the computer system, in which no use is made of the common key table. On the other hand, if the computer system is not in PC mode, step S30, the background program loads the common key table corresponding to the functional application program. For example, when the background program detects that the computer system is executing the DVD player application program, the background program loads common key table 10, which carries a corresponding relationship for DVD player function keys. When the background program detects that the computer system performs TV application program, the background program loads the common key table 20, carrying a corresponding relationship for TV application program function keys.

Users can now use common keys from the common key table as function keys of the application. In step S50, the computer system determines whether an entry key pushed by user is a common key. If so in step S60, the common key table is loaded by background program to convert the entry key to correspond with the function key of the application assigning the function key. For example, the function keys of the DVD player application and TV application as in step S10 are normalized do the common key is table. Thus, the [Enter] key, in both the DVD and the TV application programs performs play function. Common keys such as [←] and [→] adjust the volume both the DVD player and the TV application.

On the other hand, if user pushes an entry key not registered as a common key, in step S70, the background program does not act but the application program performs the normal function of the key.

While the invention has been described by way of example and in terms of the preferred embodiment, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of converting keyboard command entries in a computer system, comprising the steps of:
providing a common key table recoding a corresponding relationship between a plurality of common keys and function keys used in at least one executing application program of the computer system;
activating a background program for monitoring the a functional application program of the computer system;
loading of the common key table according to the executing application program used in the computer system by the background program; and
assigning an entry key to one of the function keys defined in the functional application program according to the common key table when the function corresponds to one of the common keys.

2. The method as claimed in claim 1, wherein the background program does not converting the common key to a function key when the entry key's function is not one of the common keys.

3. The method as claimed in claim 1, further comprising, the computer system executes an application program not including the common key table, the background program not converting the common key to a function key.

4. The method as claimed in claim 1, wherein the common keys correspond to the same or similar functions in different applications.

5. A storage medium storing a background program for converting entry keys of keyboard, comprising the steps of:
a providing a common key table recoding a corresponding relationship between a plurality of common keys and function keys used in at least one executing application program of the computer system;
activating a background program for monitoring the functional application program of the computer system;
loading of the common key table according to the executing application program used in the computer system by the background program; and
assigning an entry key to one of the function keys defined in the functional application program according to the common key table when the function corresponds to one of the common keys.

6. The storage medium as claimed in claim 5, wherein the background program does not converting the common key to a function key when the entry key's function is not one of the common keys.

7. The storage medium as claimed in claim 5, further comprising, the computer system executes an application program not including the common key table, the background program not converting the common key to a function key.

8. The storage media as claimed in claim 5, wherein the common keys correspond to the same or similar functions in different applications.
